(19) United States
(12) Patent Application Publication
(10) Pub. No.: US 2018/0114656 A1
(43) Pub. Date: Apr. 26, 2018

(54) Switch Assembly with Integrated Switch Module Housings

(71) Applicant: Omron Automotive Electronics Co., Ltd., Aichi (JP)

(72) Inventor: Alexandru Salagean, Mississauga (CA)

(21) Appl. No.: 15/639,211

(22) Filed: Jun. 30, 2017

Related U.S. Application Data
(60) Provisional application No. 62/413,137, filed on Oct. 26, 2016.

(51) Int. Cl. H01H 23/24; H01H 23/04; H01H 23/16

(52) U.S. Cl. CPC H01H 23/24; H01H 23/16; H01H 23/04

(57) ABSTRACT

In one aspect, a switch assembly includes two or more switch modules of different types and comprising different switch module subassemblies. The switch assembly also includes a switch housing having two or more sets of features integrally molded or formed in an underside or interior surface of the switch housing. Each set of features corresponds to a respective one of the different switch module subassemblies and comprises alignment and support features for the respective switch module subassembly.

### RELATED APPLICATIONS

This application claims priority to and benefit of U.S. provisional patent application Ser. No. 62/413,137, filed 26 Oct. 2016.

### TECHNICAL FIELD

The present invention relates to low-current power seat switches using a modular design that integrates certain features or components of switch modules into the overall switch housing.

### BACKGROUND

FIG. 1 illustrates an example two-way switch module 10 that includes a number of constituent parts making up an overall subassembly. Critical among these parts is a module housing 12 that carries or otherwise aligns various other components in the module 10, including an actuator 14 and corresponding dual plungers 16-1 and 16-2. The module housing 12 includes actuator alignment and support features 32, for aligning and supporting the actuator 14, which projects through an aperture 30 in the module housing 12. The dual plungers 16-1 and 16-2 are aligned and captured or retained by plunger retention features 34 molded into or otherwise formed in the module housing 12. The module 10 further includes an elastomeric keypad 18 operated on by the plungers 16-1 and 16-2, and an underlying Printed Circuit Board (PCB) 20 and supporting module base 22.

FIG. 2 illustrates the same module 10 in assembled form, and it shows the actuator 14 projecting through the aperture 30 in the module housing 12, for actuation by a human operator (although the actuator 14 may be covered by a finished knob or other aesthetically pleasing element). FIG. 2 also shows how the actuator alignment and support features 32 align and support the actuator 14. FIG. 2 further shows how the dual plungers 16-1 and 16-2 are aligned and captured or retained by the plunger retention features 34.

FIGS. 3 and 4 illustrate a similar example involving a four-way rocker-type switch module 40, which includes a similarly complex module housing 42. As with the module housing 12 seen in FIGS. 1 and 2, the module housing 42 includes several physical features providing for support, alignment and retention of multiple constituent parts of the module 40. Likewise, FIGS. 5 and 6 illustrate a further example involving a four-way switch module 50, such as might be used for lumbar support adjustment in a passenger vehicle seat. The switch module 50 includes a module housing 52, which incorporates several physical features providing for support, alignment and retention of multiple constituent parts of the module 50.

Alignment represents one of the challenges associated with the use of individual modules like those seen in FIGS. 1-6, as it is common to aggregate such switch modules together within a larger assembly within which the individual modules are installed. Typically, the overall assembly cover in which the individual switch modules are installed includes apertures corresponding to the respective switch modules included within it, meaning that the switch modules must be aligned and mounted within the larger assembly.

### SUMMARY

Embodiments of the present invention include switch assemblies that provide for better alignment and mounting of switch modules with the switch housing.

According to some embodiments, a switch assembly includes two or more switch modules of different types and comprising different switch module subassemblies. The switch assembly also includes a switch housing having two or more sets of features integrally molded or formed in an underside or interior surface of the switch housing. Each set of features corresponds to a respective one of the different switch module subassemblies and comprises alignment and support features for the respective switch module subassembly.

According to other embodiments, a switch assembly includes two different switch module subassemblies corresponding to different types of switch modules and a switch housing having sets of features that are integrally molded or formed in the switch cover as a first switch-module housing for one of the switch module subassemblies, and as a second switch-module housing for the other one of the switch module subassemblies. Each switch-module housing comprises alignment and support features for automatically aligning constituent parts of the respective switch module subassemblies. The switch assembly also includes a switch cover configured to cover the switch housing. The switch cover has a visible exterior surface through which one or more knobs or switches corresponding to the two different types of switch modules project.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 illustrates an exploded view of an example of a two-way switch module.

FIG. 2 illustrates the switch module of FIG. 1 in assembled form.

FIGS. 3 and 4 illustrate an example of a four-way rocker-type switch module.

FIGS. 5 and 6 illustrate an example of a four-way switch module.

FIG. 7 illustrates a switch assembly according to an embodiment of the present invention.

FIG. 8 illustrates the switch assembly of FIG. 7 in a perspective view.

FIG. 9 illustrates an exploded view of the switch assembly of FIG. 7.

FIG. 10 illustrates, in more detail, integral switch-module housing features on the underside or interior side of the switch housing shown in FIG. 9.

FIG. 11 provides a top view of the switch housing shown in FIG. 9.

FIG. 12 provides another underside perspective view of the switch housing of FIG. 9.

FIG. 13 shows a top perspective view of the switch housing of FIG. 9 with the various switch modules installed.

### DETAILED DESCRIPTION

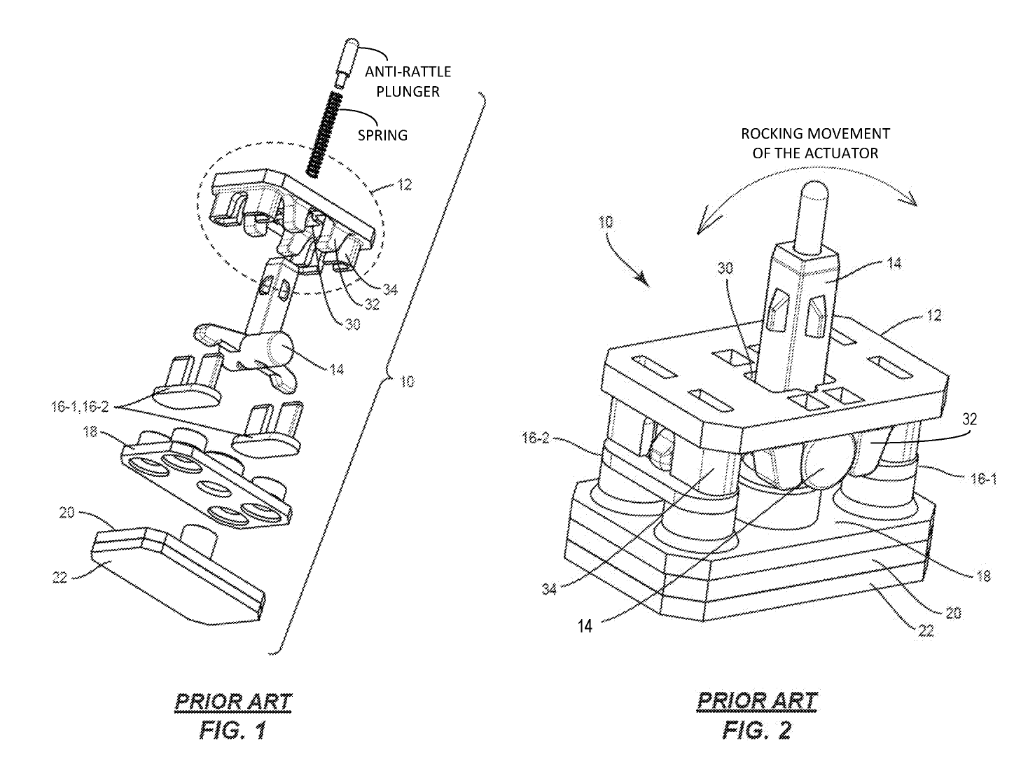

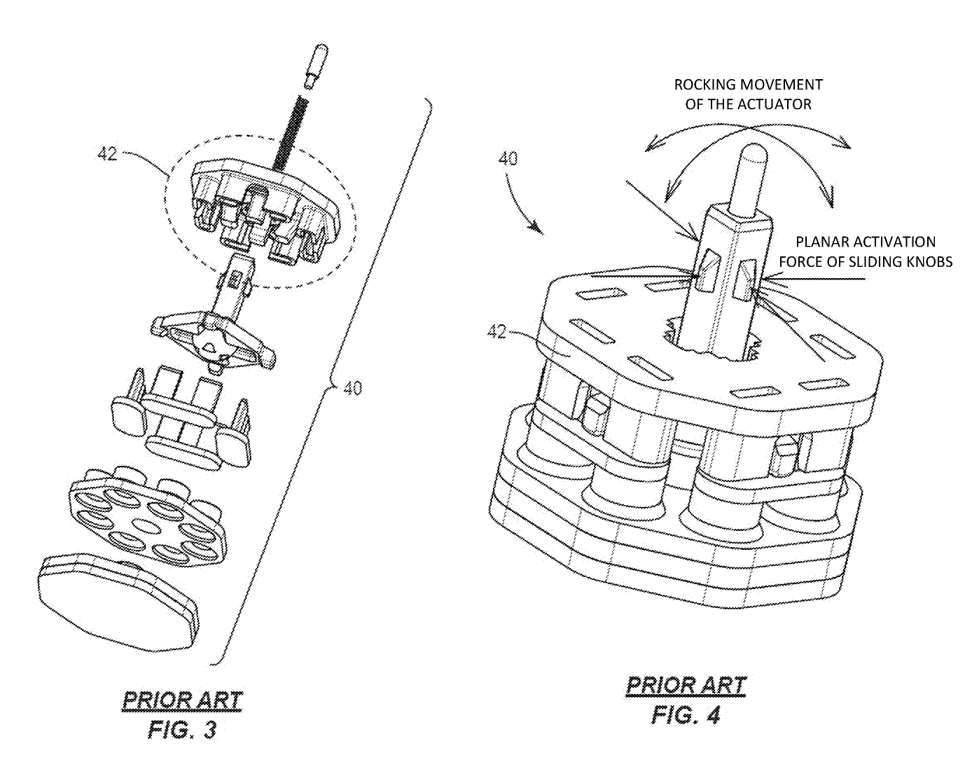

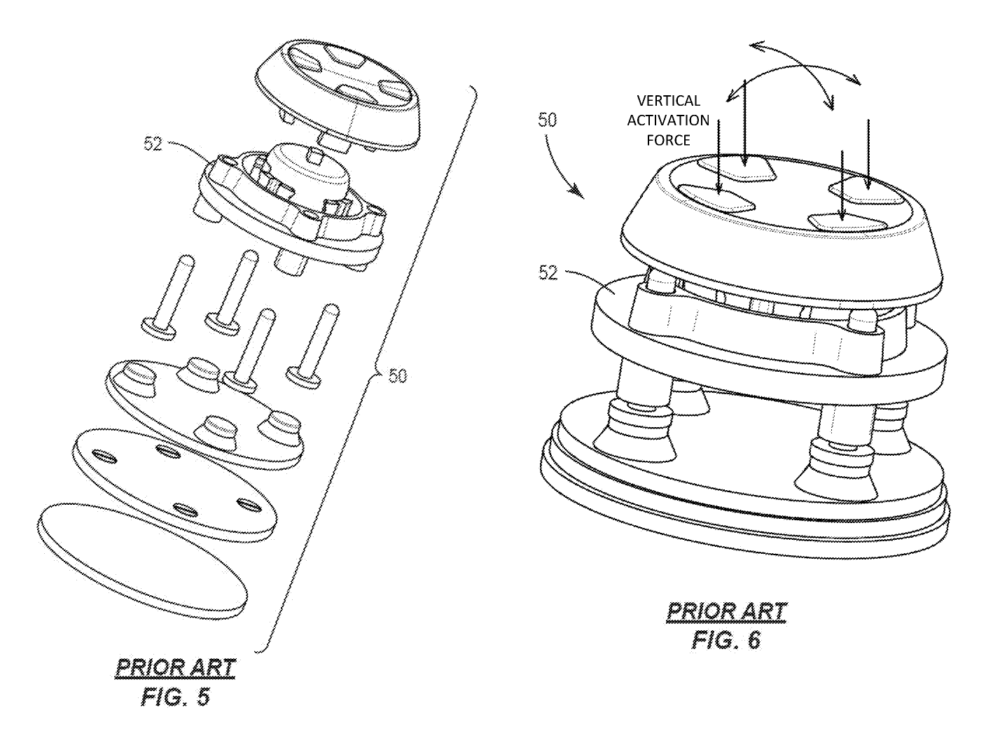

Among its various other advantages, a switch assembly according to the teachings herein solves the aforementioned problem of switch module alignment, based on incorporating the individual switch-module housings into an overall switch cover. That is, rather than each switch module having its own housing, the individual switch-module housing features are incorporated into the larger switch cover used for the overall switch assembly, which means fewer components, easier assembly, and “automatic” alignment of the individual switch modules within the larger switch assembly. As an example, the module housings 12, 42, and 52, respectively seen in FIGS. 1, 3, and 5, may be molded into or otherwise integrally formed in a larger switch housing.

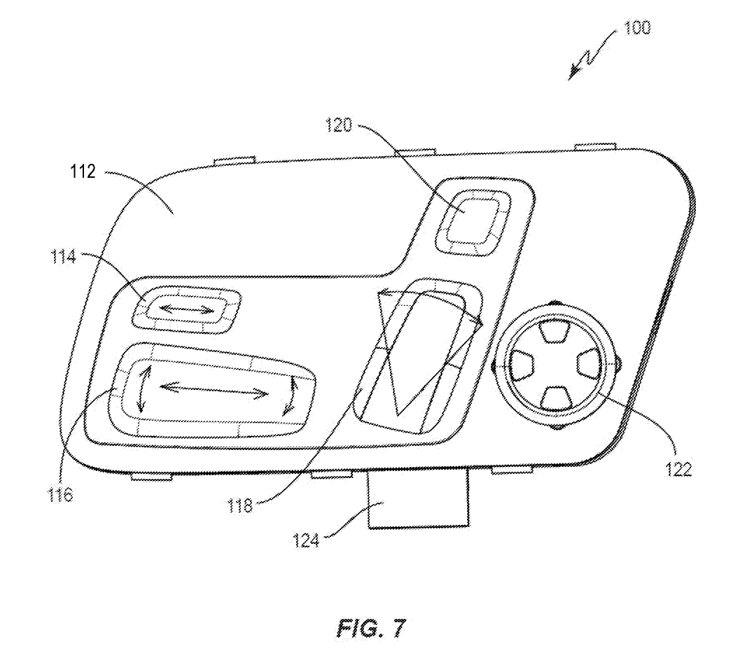

FIG. 7 illustrates an example switch assembly 100. The illustrated assembly 100 includes a switch cover 112 and one or more switch control knobs. In an example embodiment, the switch assembly 100 comprises a power seat switch assembly, and it includes multiple control knobs corresponding to various seat controls as might be implemented for a seat in a passenger car or another type of vehicle. By way of example, the assembly 100 includes a “thigh adjust” knob 114, a “cushion adjust” knob 116, a “back adjust” or “tilt adjust” knob 118, a “headrest adjust” knob 120, and a “lumbar support adjust” knob 122. A wiring or connector port 124 provides for connection of the assembly 100 to power.

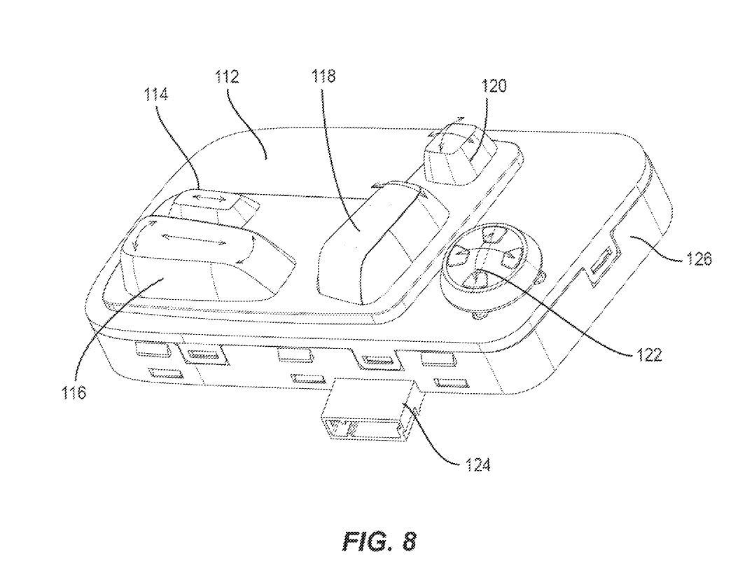

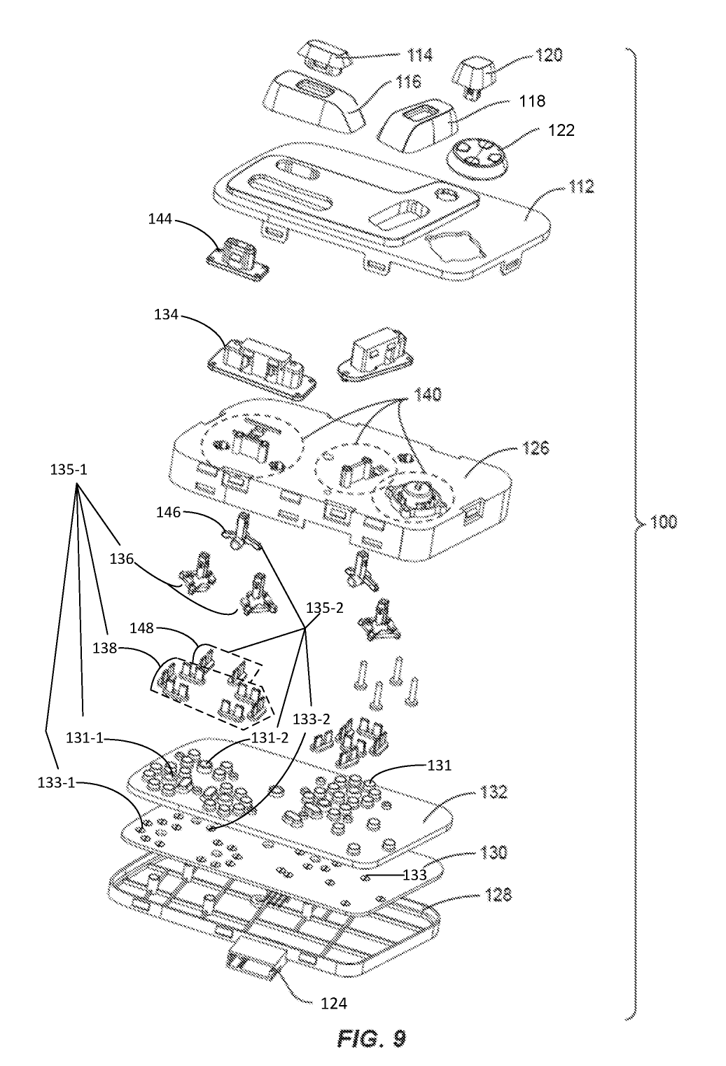

FIG. 8 illustrates the same assembly 100 in a perspective view that reveals a switch housing 126 “below” the switch cover 112. In one or more embodiments, the switch cover 112 snaps to or otherwise engages with the switch housing 126. FIG. 9 provides further example details for the assembly 100, showing an exploded view of the assembly 100 according to one implementation. Most notably, FIG. 9 reveals certain switch housing features of interest in this disclosure. Namely, in the example context of FIG. 9, the switch housing 126 includes integral switch module features 140 that are molded or formed in the switch housing 126. For example, the switch module features 140 may have been included in the same mold or molds as the switch housing 126. In another example, the switch module features 140 may formed in an underside or interior surface of the switch housing 126, meaning that the switch module features 140 are formed from the switch housing 126 to have one or more support portions (and optionally retention portions) that protrude from the underside or interior surface of the switch housing 126. Among their several advantages, the integral switch module features 140 provide for automatic alignment of the individual switch module subassemblies carried in the assembly 100, reduce the overall parts count, and ease assembly.

As an example implementation referenced to the details of FIG. 9, a “cushion adjust switch module” comprises the aforementioned cushion adjust knob 116 and a seat cushion actuator 134, along with a corresponding switch module subassembly 135-1. The switch module subassembly 135-1 shall be understood as the collection of switch-related components that provide the electrical functionality associated with the overall switch module, which, here, corresponds to the seat-cushion adjustment feature activated via physical manipulation of the cushion adjust knob 116.

Advantageously, the corresponding set of features 140 in the switch housing 126 include support and alignment features that provide for “automatic” alignment of the switch module subassembly 135-1, which includes a multiplicity of components. In this example, the switch module subassembly 135-1 includes an associated pair of 3-way actuators 136 and dual plungers 138, a number of keys or contacts 131-1 on an elastomeric keypad 132 and corresponding contacts or lands 133-1 on a printed circuit board 130. A switch base 128 provides support for the overall assembly 100 and the switch modules contained therein.

In an example of a switch module of another type, a “thigh adjust switch module” comprises the depicted thigh adjust knob 114 and a thigh adjust actuator 144, along with a corresponding switch module subassembly 135-2. Here, the switch module subassembly 135-2 includes an associated 2-way actuator 146 and dual plungers 148, a number of keys or contacts 131-2 on the elastomeric keypad 132 and corresponding contacts or lands 133-2 on the printed circuit board 130.

In some sense, the overall assembly 100 can be understood as a collection of interlocking or aligned individual parts stacked between the switch base 128 and the switch cover 112. Correspondingly, the integral switch module features 140 formed in the switch housing 126 not only simplify assembly and facilitate parts alignment, they reduce the overall parts count by incorporating certain switch module components into the switch housing 126 that were heretofore implemented as separate parts of the various switch modules—see, e.g., the example module housings 12, 42, and 52, separately implemented for the individual switch modules depicted in FIGS. 1, 3, and 5.

For the embodiment of the present invention shown by switch assembly 100, the interior or underside of the switch housing 126 includes respective sets of physical features 140 configured as module housings for assembling and retaining the thigh-adjust switch module, the cushion-adjust switch module, and the various other switch modules included within the overall switch assembly 100.

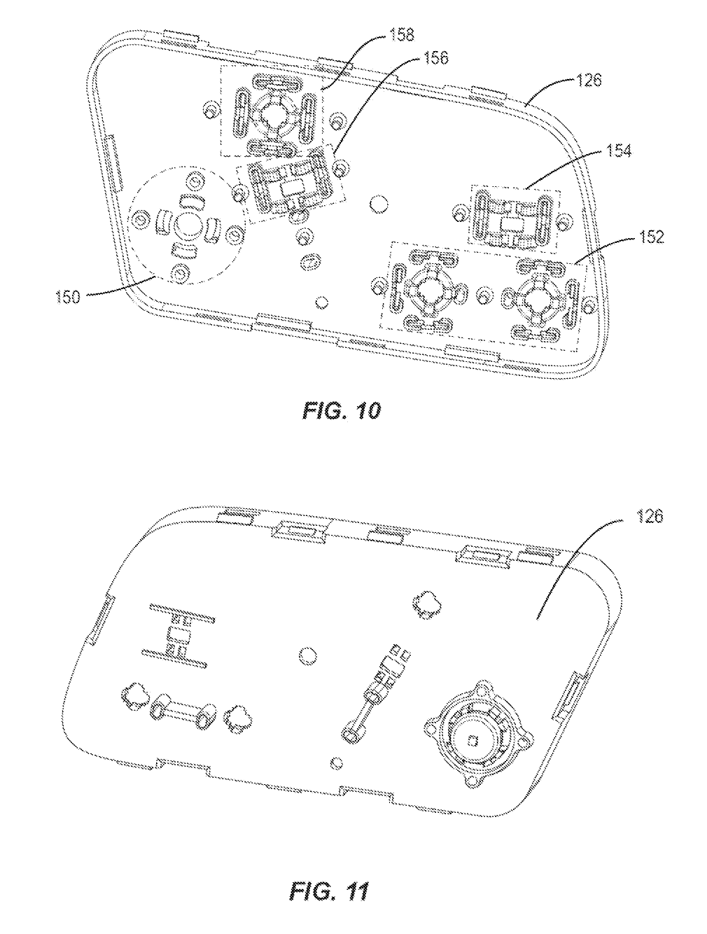

Consider FIG. 10 where the integral switch-module housing features 140 generally referenced in FIG. 9 are shown in more detail, from the underside view, as distinct sets of housing features 150, 152, 154, 156, and 158. The reference number 150 denotes a set of module housing features formed in the switch housing 126 for a switch module subassembly included in an overall lumbar adjustment switch module. These features provide for alignment and support of the remaining components of a lumbar adjustment switch module that is capped by the lumbar adjustment knob 122 introduced in FIG. 8. These features may also include retention features for aligning and retaining plungers, which are components that stabilize the rest position and movements of the actuator.

Similarly, the reference number 152 denotes a set of module housing features formed in the switch housing 126 for a switch module subassembly 135-1 in an overall seat-cushion adjust switch module. These features provide for support and alignment of the remaining components of the cushion adjust switch module that is capped by the seat cushion adjust knob 116 introduced in FIG. 8. Likewise, the reference numbers 154, 156, and 158 provide integral switch module housing features for corresponding switch module subassemblies associated with the further adjustment knobs 114, 118 and 120 seen in FIG. 8.

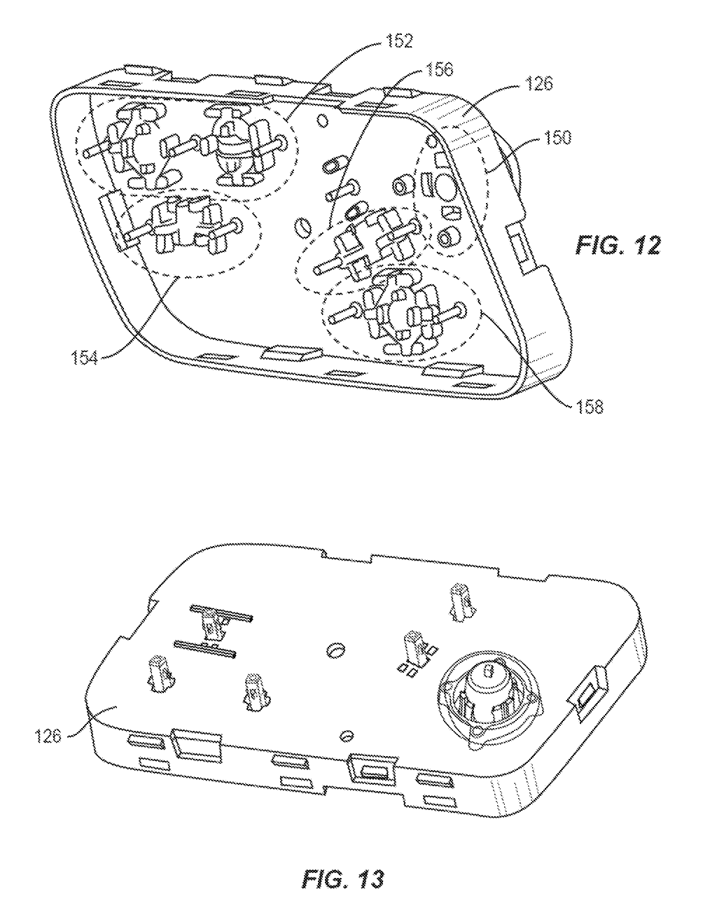

FIG. 11 provides a top view of the same switch housing 126, while FIG. 12 provides an underside perspective view of the switch housing 126 with installed switch module components seated in or mated with the integral switch module housing features 140 (e.g., 150, 152, 154, 156, and 158) introduced in FIG. 9. FIG. 12 is a view that is upside-down as compared to FIG. 10. FIG. 13 shows a top perspective view of the switch housing 126 with the various switch modules installed, and depicts the projection of the associated switch actuators through apertures of the switch housing 126.

In one sense, there may be multiple switch module subassemblies 135 between the switch base 128 and the switch cover 112 that use different areas or portions of the same switch housing 126. Here, the reference number “135” without suffixes is used to denote any given switch module subassemblies in the singular sense or plural sense. Each subassembly may be considered to be operatively completed when it is assembled in combination with its corresponding switch-module housing.

As will be appreciated from the description and drawings, integrating switch module features into the switch housing 126 effectively integrates multiple switch module housings rather than leaving them as separate components for the involved switch modules. This approach simplifies inventory management and handling, eases assembly, and improves quality, e.g., through automatic alignment, repeatability, etc. Moreover, multiple switch modules of different types can be accommodated by forming the corresponding appropriate switch module housing features in different areas of the switch housing 126, i.e., at the desired locations or positions of the respective switch modules.

Notably, modifications and other embodiments of the disclosed invention(s) will come to mind to one skilled in the art having the benefit of the teachings presented in the preceding descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A switch assembly comprising:
two or more switch modules of different types and comprising different switch module subassemblies;
a switch housing having two or more sets of features integrally molded or formed in an underside or interior surface of the switch housing, each said set of features corresponding to a respective one of the different switch module subassemblies and comprising alignment and support features for the respective switch module subassembly.

2. The switch assembly of claim 1, wherein a first set of the features is configured as a switch-module housing for a first type of switch module and a second set of the features is configured as a switch-module housing for a second type of switch module.

3. The switch assembly of claim 2, wherein at least one of the two or more switch modules comprises a rocker-type switch module having a rocker actuator operative to act on one or more plungers, and wherein the switch-module housing includes actuator support features configured to retain the rocker actuator in an operative position and plunger retention features configured to hold the one or more plungers in an operative position relative to the rocker actuator.

4. A switch assembly comprising:
two different switch module subassemblies corresponding to different types of switch modules;
a switch housing having sets of features that are integrally molded or formed in the switch cover as a first switch-module housing for one of the switch module subassemblies, and as a second switch-module housing for the other one of the switch module subassemblies, each switch-module housing comprising alignment and support features for automatically aligning constituent parts of the respective switch module subassemblies; and
a switch cover configured to cover the switch housing, the switch cover having a visible exterior surface through which one or more knobs or switches corresponding to the two different types of switch modules project.
